(19) United States
(12) Patent Application Publication
(10) Pub. No.: US 2026/0115849 A1
(43) Pub. Date: Apr. 30, 2026

(54) APPARATUS AND METHOD FOR AUTOMATICALLY HANDLING HOLLOW CYLINDRICAL TOOLS

(71) Applicant: Heinrich Georg GmbH Maschinenfabrik, Kreuztal (DE)

(72) Inventor: Tillmann Bäumener, Kreuztal (DE)

(21) Appl. No.: 19/366,879

(22) Filed: Oct. 23, 2025

(30) Foreign Application Priority Data
Oct. 24, 2024 (EP) 24208667.6

(51) Int. Cl. B23Q 3/155; B23Q 3/157

(52) U.S. Cl. CPC B23Q 3/15503; B23Q 3/15713

(57) ABSTRACT

An apparatus and method for automatically handling hollow cylindrical tools, including tools without a reduction in a wall thickness on an inner edge of slitting lines, where the apparatus includes a gripping head that has at least two radially extendible gripping fingers that each form an angle of greater than 90 degrees therebetween and are designed to be movable radially between a rest position and a gripping position in order to engage into the tools in the rest position and to clamp them in a splaying manner in the gripping position, where the gripping fingers each have a device for generating a directed repulsive force in the end region. In a particular embodiment the gripping head includes three gripping fingers. The gripping head may additionally include a vibration device operable to vibrate the fingers for separating an adhered adjacent hollow cylindrical tool.

### BACKGROUND AND FIELD OF THE INVENTION

The invention relates to an apparatus for automatically handling hollow cylindrical tools.

In so-called slitting lines, metal bands are cut in a longitudinal direction into narrower strips. For this purpose, they typically have slitting shears which are designed as cylindrical blade bars or blade shafts, onto which hollow cylindrical tools, such as rotary shear blades, distance rings and ejector rings as well as an end circlip are slid.

The rotary shear blades cut the material, the ejector rings, guide the material and the distance rings set the desired cutting widths and cutting gaps. The end circlips form the end of a tool structure and prevent the tools from slipping laterally. The end circlips serve as pressure rings and transmit a clamping force which is applied by means of a hydraulic nut and fixedly clamps the entire tool package on the blade shaft. By virtue of the corresponding arrangement of the tools on the blade shaft, it is possible to produce the slitting shears.

The slitting shears or the tools thereof are often prefabricated on arms of front frames. In this regard, it is known to provision the hollow cylindrical tools in such a way that they are slid on storage arms. They are then removed as required and slid onto the arms of the blade front frame or onto the cylindrical blade shafts. This can be effected manually or even with robot assistance.

It is known to use apparatuses for automatically storing (provisioning) the hollow cylindrical tools which have at least one rotatable carousel tower with a plurality of radial arms in levels arranged one above the other. A movable gripper handles the tools for placement or removal from the radial arms.

For instance, a so-called STAHL-2 blade construction robot is known from the company Make SRL (https://www.makeitaly.com) and comprises a storage area in which the tools are stored in a carousel tower on radial arms which are arranged alternately on levels arranged one above the other and so the arms are vertically aligned on each second level. The storage is effected with a large spaced interval between the arms (cf. https://www.youtube.com/watch?v=5e0BRORZaik at 1:18 minutes). The company Scandinavian Robotics AB (https://www.scanrobotics.se/en/2018/12/14/new-developed-robot-system/) also provides similar systems.

DE 10 2014 014918 A1, EP 2 193 890 A1 and EP 1 142 662 A1 describe e.g. grippers which are used in order to handle the corresponding tools. For example, EP 1 142 662 A1 describes a gripper which uses an extendible inner gripper to access the ring-shaped tools. The inner gripper has three splayable fingers which are arranged in a uniformly distributed manner with respect to one another.

A general problem encountered with the storage and handling of the tools is that, in order to save space, multiple tools are stored lying next to one another and against one another on the arms. The tools tend to adhere to one another and must be detached from one another for individual removal or handling.

For this purpose, in the case of tools having greater wall thicknesses it is known to use wedge-like gripping fingers to engage into the dirt grooves present at this location in order to separate the tools. This is because the dirt grooves which are opposite one another at this location form together a type of pocket which is created by the reduction in the wall thickness of the mutually opposite surfaces of the tools which is present at this location. This pocket permits an easy engagement option.

However, it is difficult to handle tools individually, in particular very thin tools having material thicknesses less than or equal to 3 mm, without these dirt grooves or other reductions in the wall thickness because the tool planar surfaces lie against one another at these locations. For instance, DE 10 2014 014918 A1 discloses the use of a separate separating gripper in order to hold back the second tool.

WO 2004/098839 A1 discloses the use of repulsive magnetic fields in the tools, which are to be separated, during the gripping procedure. EP 2 193 890 A1 describes a demagnetisation method suitable for this purpose.

### SUMMARY OF THE INVENTION

The present invention provides an improved way of individually handling hollow cylindrical tools, in particular tools without a reduction in the material thickness at the edge. This is also intended to make tools having thin material thicknesses easy to grip. Advantageous embodiments are apparent from the below description.

In accordance with an aspect of the invention, it has been recognised that, if the gripping fingers each have a device for generating a directed repulsive force in the end region, it is possible in a target-oriented manner to separate the tool, which is to be grasped, from the tool lying against it. In other words, a force is generated in a targeted manner in the gripping fingers themselves in order to repel the unwanted adhering tool, so that only the clamped tool is actually moved during handling.

In the present case, the term “targeted” is to be understood to mean that the force is directed away from the clamped target tool towards the unwanted adjacent tool in order to detach it from the wanted target tool as efficiently as possible.

In one embodiment, the device for generating a targeted repulsive force is a compressed air nozzle. It can have compressed air supplied to it in a controlled manner in order to blow the unwanted tool away. The compressed air nozzle can extend in the axial-radial direction in an oblique manner from the inside to the outside in the direction of access in order to improve the blowing action. A plurality of compressed air nozzles can also be provided. It is preferable if each compressed air nozzle is oriented in the axial-radial direction in an oblique manner from the inside to the outside in the direction of access or in the opposite direction. The compressed air supply can be effected in a controlled manner continuously and/or pulsatingly or intermittently.

In order to assist with the individual handling and separation of the tools from one another, the gripping head can additionally have a vibration device. The tools can then be additionally separated by the shaking which results during the gripping procedure. The vibration device can make either the entire gripping head vibrate or, in a targeted manner, can make only the gripping fingers vibrate. Therefore, the vibration can be transmitted in a controlled manner to the tools.

A linear drive can be provided in order to retract and extend the gripping fingers between the rest position and the gripping position. A toggle lever mechanism is preferred. However, it is also feasible to use toothed racks, electric linear drives with spindle axles and ball screws, folding spindles, cam disks, traction drives, etc. It is also possible to use hydraulic cylinders and pneumatic cylinders or electromechanical linear drives, such as a linear motor with an electrodynamic operating principle, linear actuators with a piezoelectric operating principle, with an electrostatic operating principle, with an electromagnetic operating principle, with a magnetostrictive operating principle, with a thermoelectric operating principle.

In order to accommodate different inner diameters of the tools and to generate different clamping forces, the gripping fingers can be designed to be movable radially in a controlled manner with regard to the extent of the extension length. It is possible to set the force separately and individually via the controller or software and, in the case of recurring tools, to achieve targeted presetting for the best clamping force.

In a particular embodiment, the linear drive is a toggle lever mechanism and the toggle lever mechanism is driven via a ball screw drive. The ball screw drive allows the toggle lever mechanism to be moved in a continuously variable and precise manner.

The gripping fingers can each form an angle of 120 degrees, for example, if three are provided. They are then arranged preferably in a Y-shape. The gripping fingers can be designed to be identical or different. For instance, it is possible to design the two upper gripping fingers to be identical and to design the lower gripping finger to be different. The gripping fingers can also be designed to be interchangeable on the gripping head.

For the wedge-shaped separation of the tools, the gripping fingers can each have a tapering end region (push-off wedge) so that even larger tools as standard can be separated and gripped from behind.

For improved splay-clamping, the gripping fingers can have an outer and/or inner clamping shoulder at the transition to the tapering end region. The compressed air nozzle(s) can also have their outlet or can be arranged in this region. In particular, the lower gripping finger can be designed differently. For this purpose, it can have a different extension and can also have a push-off groove in addition to the push-off wedge and clamping shoulder. The push-off wedge is then aligned with those of the remaining gripping fingers, and the clamping shoulder is spaced apart therefrom by means of the push-off groove, and so the clamping shoulder protrudes further in the gripping direction than those of the remaining gripping fingers. Therefore, it becomes possible in a splaying manner to clamp and thus to grip the desired tool with the remaining (e.g. upper) gripping fingers and at the same time to hold back the unwanted rear tool with the offset clamping shoulder and to assist with the gripping and removal of the desired tool through the push-off groove. Accordingly, during splaying the desired tool is pushed upwards by the clamping shoulder of the upper gripping fingers and thus moves away from the radial arm, on which it is stored. To prevent the rear adhering tool from also sliding upwards, it is held down by the lower gripping finger with its offset clamping shoulder.

By virtue of the fact that the rear adhering tool slides in front of the compressed air nozzles of the upper gripping fingers, the effect of the compressed air repelling the tool located behind it increases. In this case, all three gripping fingers extend uniformly at the same time. If the gripping fingers are fully extended, the unwanted tool is held or clamped by means of the clamping shoulder of the lower gripping finger, and the gripping head can move away with the desired tool.

In addition, the compressed air nozzles on the clamping shoulder of the lower gripping finger can be designed differently. The compressed air nozzles can be oriented in the opposite direction to the remaining ones, extending in the axial-radial direction obliquely from the outside to the inside in the direction of access and extending in the opposite direction, and so the compressed air is ejected towards the wedge-shaped tip (push-off wedge) and acts on the desired tool.

The invention also relates to a method for automatically handling an individual hollow cylindrical tool from a group of tools lying against one another, in particular a hollow cylindrical tool without a reduction in the wall thickness at the edge, optionally using an apparatus described above, wherein the hollow cylindrical tool is held in a clamping manner from the inside by introducing and spreading the gripping fingers of a gripping head, and then the gripping fingers generate a directed repulsive force and/or vibrate in order to detach further tools adhering to the tool.

Further details of the invention will become clear from the following description of exemplified embodiments by reference to the drawings.

### BRIEF DESCRIPTION OF THE DRAWINGS

FIG. 1 shows a schematic perspective view of an apparatus for automatically storing cylindrical tools from the side of the handling system with an open enclosure;

FIG. 2 shows a schematic side view of a tower, occupied by tools, of FIG. 1;

FIG. 3 shows a plan view from above of the tower of FIG. 2;

FIG. 4 shows a schematic perspective view of the upper region of a tower which is not filled with tools, of FIG. 1;

FIG. 5 shows a schematic perspective view of the handling system of FIG. 1;

FIG. 6 shows a schematic perspective view of the gripping head of FIG. 5;

FIG. 7 shows a sectional view of the gripping head of FIG. 5;

FIGS. 8 and 9 show a schematic side view in the region of the upper gripping fingers during handling of a distance ring; and

FIG. 10 shows a schematic side view in the region of a different lower gripping finger.

### DESCRIPTION OF THE PREFERRED EMBODIMENTS

The figures illustrate an apparatus for automatically storing cylindrical tools, which is designated as a whole by 1.

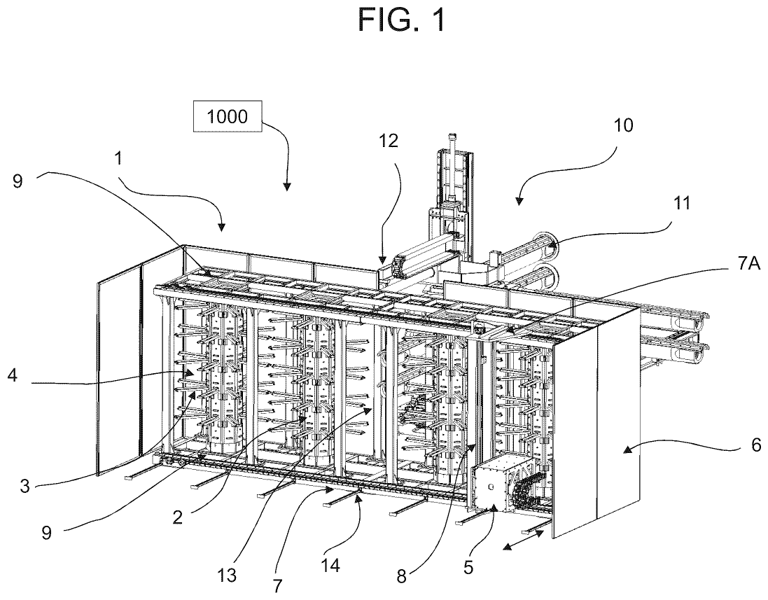

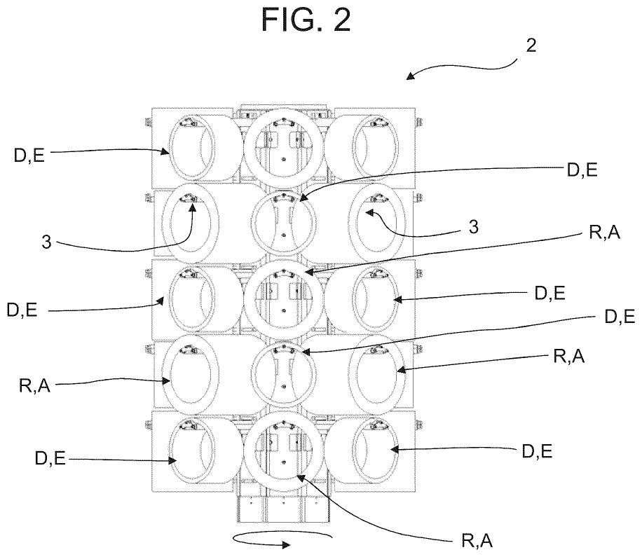

The apparatus 1 comprises a plurality of rotatable towers 2 which are arranged along a straight line and have a plurality of radial arms 3 on levels 4 arranged one above the other and a handling system 5 which is movable vertically along the towers 2 for handling the tools, and a controller 1000 for controlling the entire apparatus. The towers 2 and also the handling system 5 are located in an, optionally mobile, enclosure 6 in order to protect the tools from environmental influences and contamination. For an improved overview, a longitudinal side and the top side of the enclosure 6 have been omitted in FIG. 1. The tools are rotary shear blades R, distance rings D and ejector rings A and end circlips E which are used in a slitting line.

The enclosure 6 has a lower movement path 7 for the handling system 5 on a longitudinal side next to the towers 2, so that said handling system can be moved within the enclosure 6 to the towers 2 in order to handle the tools. In addition to the longitudinal movement, the handling system 5 can also be moved vertically on a mast 8 in order to reach all levels of the radial arms 3.

The towers 2 are mounted on a support frame 9 arranged within the enclosure 6, wherein they are stored and guided on both sides, i.e. at the top and bottom, in the support frame. The controlled drive for rotating the towers 2 is flange-mounted from above from the support frame 9.

When moving, the handling system 5 is guided and driven on the support frame 9 on the movement path 7 at the bottom and on a guide 7A at the top. For this purpose, a rack and pinion drive is implemented both at the bottom and top, and a linear guide is provided at the top and bottom.

In addition to the horizontal and vertical movement, the handling system 5 is also designed to be (further) extendible in order to push the picked-up tools onto the arms 11 of a blade front frame 10 or onto the blade shaft.

On the side of the enclosure 6 facing away from the movement path 7, a closable opening 12 is provided, through which the handling system 5 or the gripping head 17 thereof can reach the blade front frame 10 in order to remove and supply arms 11 or blade shafts located thereon. Corresponding to the opening 12, a gap 13 is provided between the towers 2 so that the gripping head 17 of the handling system 5 can be guided through. For this purpose, the blade front frame 10 can be moved with the arm 11 or blade shaft to be fitted so as to be introduced into the enclosure 6. Alternatively, it is possible that the handling system 5 or the gripping head 17 thereof can be extended sufficiently in order to reach the arm 11 or the blade shaft without them being introduced into said enclosure.

The entire enclosure 6, including all components, is placed on a movement frame 14 so that the enclosure 6 is movable relative to the blade front frame 10.

Each tower 2 can be rotated in a controlled manner via motor-controlled adjustable drives in order to present the desired radial arms 3 for storing or transferring a specific tool R, A, E, D to the handling system 5. The radial arms 3 protrude radially outwards from the vertical tower 2, which can be rotated in a controlled manner, so that said arms can be served by the handling system 5 which can move towards them from the side 5 when the tower 2 has been rotated accordingly in order to present the corresponding radial arm 3 which carries or is to pick up the desired tool R, A, E, D. The movement path 7 of the handling system 5 is positioned accordingly.

The radial arms 3 consist of a central radially extending tubular support rod 3A. In addition, tubular supporting rods 3B, C are provided on the left and right in parallel with the support rod 3A, said tubular supporting rods being arranged with their top sides in the radial view together with the support rod 3A in the manner of a pitch circle in order to form an effective support for the hollow cylindrical tools R, A, E, D.

The support rod 3A and the supporting rods 3B, C taper at the end facing away from the tower 2 in order to simplify the threading of the tools R, A, E, D. The support rod 3A and the supporting rods 3B, C are also braced together in the region of the ends, facing away from the tower 2, by means of a plate 15.

In the present case, the radial arms 3 of each level 4 are identical and arranged equally spaced apart. For each level 4, there are eight radial arms 3 for storage purposes and each tower 2 has five levels 4 for storage purposes. All radial arms 3 are the same length. The radial arms 3 of one level 4 are located directly vertically (perpendicularly) above the radial arms 3 of the level 4 therebelow or thereabove.

The smaller or narrower tools, such as the distance rings D or end circlips E, can be placed or positioned by the gripping head 17 in the front region of the radial arms such that they do not abut against the longer (or wider) and larger rotary shear blades R and ejector rings A at the rear. For this purpose, the radial arms 3 are equipped with spacers 16 which, depending on the tool provided, are positioned in the longitudinal direction of the radial arms 3 so that the respective tool either does not abut against the tower 2 and/or can be stored only in the front area of the radial arms 3 because it cannot slip towards the tower 2.

The controller 1000 is programmed to control the entire apparatus, which also includes the occupancy of the storage locations formed by the radial arms 3 and the movements of the towers 2 and the handling system 5. The controller 1000 activates the handling system 5 in such a way that tools R, A with a specific outer diameter, namely rotary shear blades R and ejector rings A, are each stored only on radial arms 3 of a tower 2 which are allocated thereto, and tools having a smaller outer diameter, namely distance rings D and end circlips E, are each stored only on radial arms 3 which are allocated thereto.

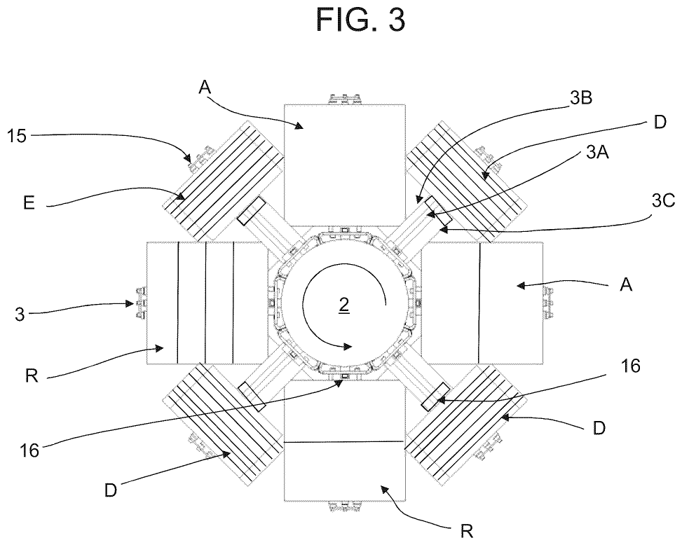

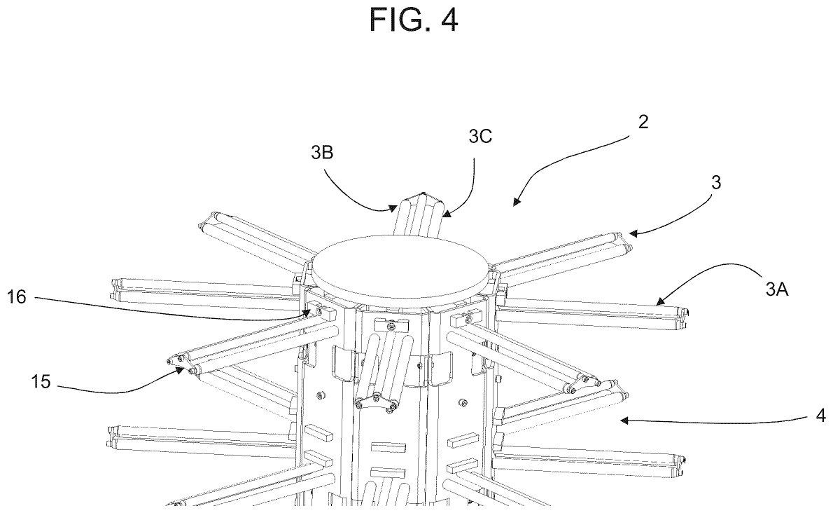

It is understood that, depending on the tool length, a plurality of tools can be stored one behind the other on the same radial arm 3 or storage location. This applies in particular to the narrow distance rings D and end circlips E (cf. FIG. 3). Multiple tools are stored one behind the other. However, depending on their width, the wider rotary shear blades R and ejector rings A are likewise often stored in twos or in multiple number one behind the other.

The tool storage area is thus divided into two different storage location types. Only rotary shear blades R and ejector rings A are stored in the first storage locations. The second storage locations are, in turn, provided exclusively for distance rings D and end circlips E.

Since the distance rings D or end circlips E have a smaller outer diameter than the circular blades and ejector rings, the spaced interval between the storage locations or the radial arms 3 which form the storage locations can be optimised by the targeted storage of the tools, always with the aim of occupying possibly all of the storage locations in order to achieve the smallest possible overall dimension. This allows the storage locations or radial arms 3 to be placed closer to one another, and so the unused space between the storage locations is reduced compared to the known storage areas. In particular, this optimises the space required vertically.

The occupancy of the radial arms 3 or storage locations is fixedly allocated according to type. This means that specific storage locations or radial arms 3 are always occupied by rotary shear blades R and ejector rings A, and storage locations or radial arms 3 of the other allocation are always occupied by distance rings D or end circlips E. The storage location types are arranged alternately.

Therefore, the spaced interval between the radial arms 3 which are arranged vertically (perpendicularly) one above the other, i.e. the spaced interval between the levels 4, is set approximately to a size corresponding to the inner diameter and the material thickness of the rotary shear blades R or ejector rings A plus the material thickness of the distance rings D or end circlips E. In addition, there is a small gap dimension of ca. 15 mm in order to enable gripping or to prevent bumping.

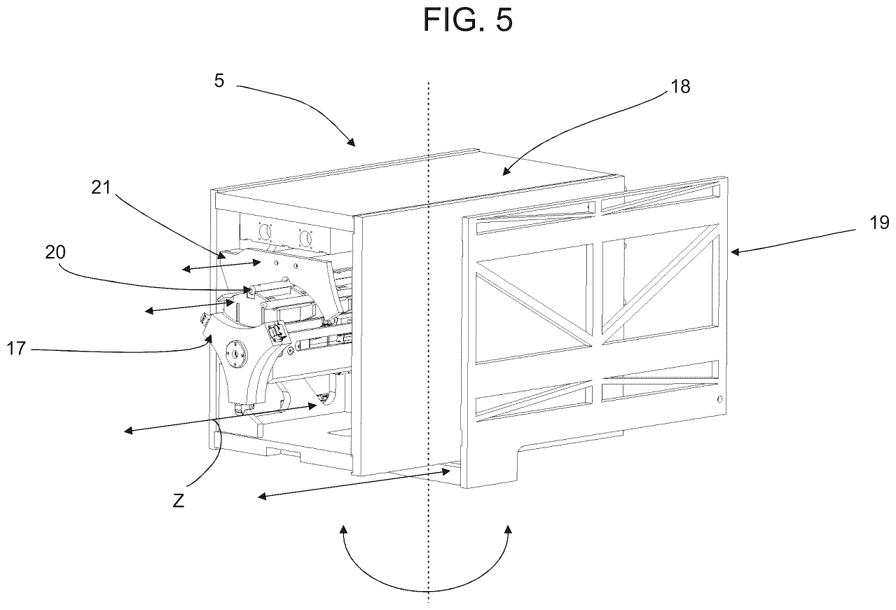

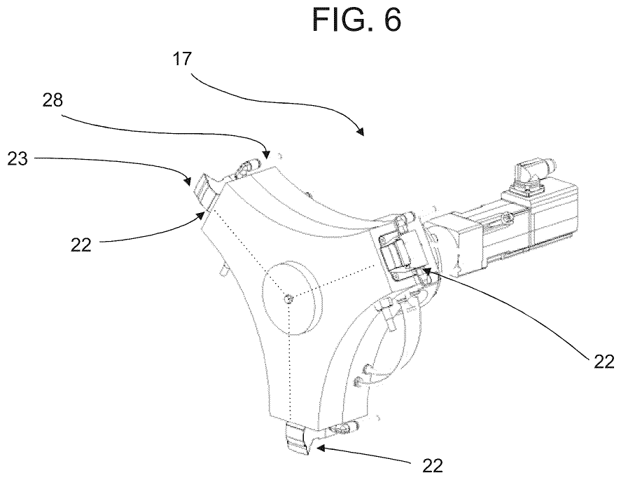

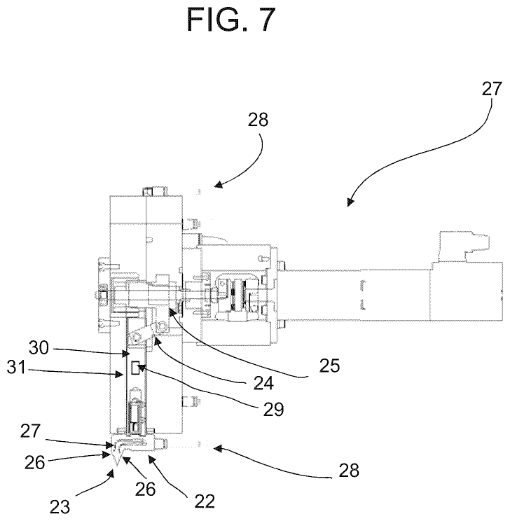

The handling system 5 is not only movable linearly horizontally along the movement path 7 and vertically along the mast 8, but also comprises a gripping head 17 which is designed to be telescoped linearly in and out from a housing 18. The handling system 5 can additionally have a vertical axis of rotation (cf. FIG. 5), making it possible to place tools on an opposite wall if necessary. The housing 18 is movably fastened to the mast 8 via a fastening plate 19. The housing 18 and the fastening plate 19 are likewise linearly movable relative to one another in order to increase the reach, in order to reach the arm 11 of the blade front frame 10 e.g. through the gap 13. The linear movements are performed by rack and pinion drives, spindle drives, electric cylinders and linear axles.

The gripping head 17 is arranged in the housing 18 below a linearly retractable and extendible support rail 20 which is used for actual transport of the tools which have been grasped. Arranged above the support rail 20 is a likewise linearly movable pusher 21 which is used for pushing down the tools transported on the support rail 20. The gripping head 17 comprises three radially (linearly) extendible gripping fingers 22 which each form an angle of 120 degrees therebetween and which each have a wedge-shaped tip 23.

The gripping fingers 22 are arranged in a Y-shape and so there is no collision with the radial arms 3 or the support rail 20 or the arm 11 of the blade front frame 10 when picking up and placing the tools. The gripping fingers 22 are designed to be movable radially between a rest position and a gripping position in order to grasp the tools in the gripping position.

The controlled linear movement of the gripping fingers 22 in their guide 31 in the gripping head 17 is effected by means of a toggle lever mechanism 24, and the toggle lever mechanism 24 is adjusted via a ball screw drive 25. The ball screw drive 25 allows the toggle lever mechanism 24 to be moved in a continuously variable and precise manner. The toggle lever mechanism 24 engages with a gripping finger body 30 which is guided in the gripping head 17 and at the end of which the end (e.g. the tip 23) actually interacting with the tool is arranged.

The gripping head 17 is designed to handle all types of hollow cylindrical tools of slitting lines. It can thus be activated in order to grasp individual hollow cylindrical tools from a group of tools lying against one another without a reduction in the wall thickness at the inner edge, i.e. distance rings D and end circlips E. They are particularly difficult to handle because, unlike rotary shear blades R and ejector rings A, they do not have a dirt groove, which forms a type of engagement pocket, and tend to adhere to one another.

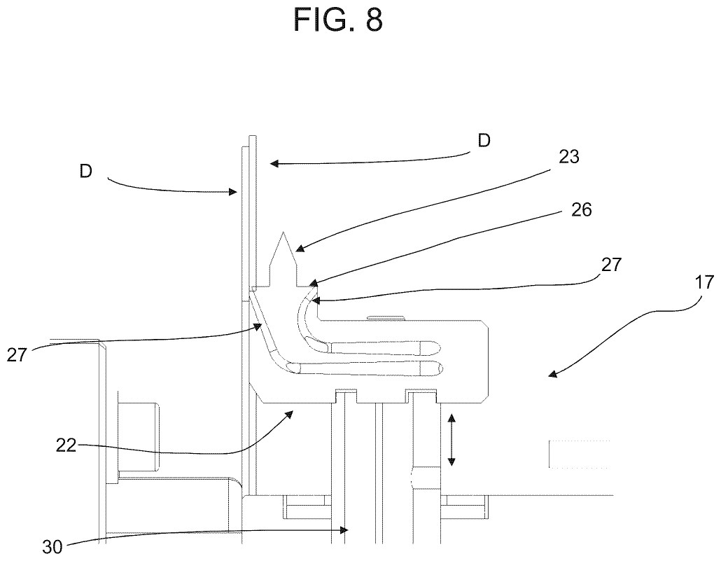

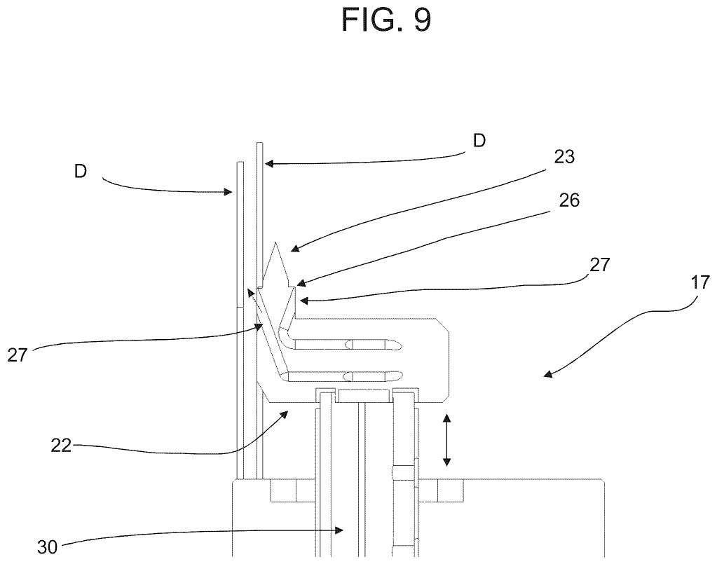

In order to grip them, the gripping head 17 with retracted gripping fingers 22 in the rest position is introduced into the respective hollow cylindrical tool and is then spread by extending the gripping fingers 22 into the gripping position by means of the toggle lever mechanism 24, wherein the respective gripping finger body 30 is moved in a radially controlled manner in the guide 31 in order to hold the respective tool D, E in a clamping manner from the inside (see FIGS. 8 and 9).

The gripping head 17 can then be withdrawn and the tool can be transferred to the support rail 20. This can be pre-positioned depending on requirement. Subsequently, both the gripping head 17 and the support rail 20 carrying the tool can be retracted into the housing 18 for protected transport.

For improved splay-clamping, the gripping fingers 22 have an outer and inner clamping shoulder 26 at the transition to the wedge-shaped tips 23. Compressed air nozzles 27 also have their outlet in this region. The actual clamping is effected by virtue of the clamping shoulders 26 lying from the inside against the inner cylindrical wall of the tool in the manner of clamping jaws.

The gripping head 17 can also be activated in order to grasp such tools with a reduction in the wall thickness on the inner edge, i.e. rotary shear blades R and ejector rings A. For this purpose, the retracted gripping fingers 22 in the rest position are introduced and guided through. The gripping fingers 22 are then extended radially in order, in the gripping position, to grip the tools from behind, wherein the wedge-shaped tips 23 of the end regions engage between the tools and separate them.

The compressed air nozzles 27 allow the gripping fingers 22 to generate a directed repulsive force in order to better detach adjacent tools which adhere to the tool. More precisely, the outlets of the compressed air nozzles 27 are located in the region below the wedge-shaped tip 23 on the clamping shoulder 26 and are supplied with compressed air via a line 28.

The compressed air nozzles 27 are oriented extending in the axial-radial direction in an oblique manner from the inside to the outside in the direction of access (arrow Z in FIG. 5) and in the opposite direction in order to improve the blowing action. The compressed air supply via the line 28 is effected in a controlled manner continuously and/or pulsatingly or intermittently, depending on requirement and setting by means of the controller 1000, from a compressed air source, not illustrated, such as e.g. a compressor which can also be integrated in the handling system 5.

In order to assist with the individual handling and separation of the tools from one another, the gripping head 17 additionally has, for each gripping finger 22, a vibrator or vibration device 29 which is integrated within the gripping finger body 30. In a targeted manner, the vibration device 29 (vibration motor) causes the gripping fingers 22 to vibrate. Therefore, the vibration can be transmitted in a controlled manner to the tools. The tools can then be additionally separated by the shaking which results during the gripping procedure.

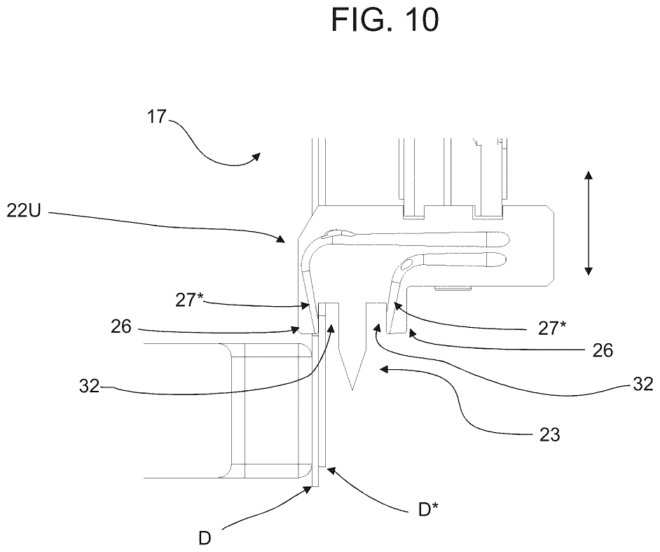

As illustrated in FIG. 10, it is possible for the lower gripping finger 22U to be designed differently. For this purpose, it can have a different extension and can also have a push-off groove 32 in addition to the wedge-shaped tip (push off wedge) 23 and the clamping shoulder 26. The push-off wedge 23 is then aligned with those of the remaining gripping fingers 22, and the clamping shoulder 26 is spaced apart therefrom by means of the push-off groove 32, and so the clamping shoulder 26 protrudes further in the gripping direction than those of the remaining gripping fingers 22. Therefore, it becomes possible in a splaying manner to clamp and thus to grip the desired tool D* (distance ring) with the remaining (e.g. upper) gripping fingers 22 and at the same time to hold back the unwanted rear tool D with the offset clamping shoulder 26 and to assist with the gripping and removal of the desired tool through the push-off groove 32. Accordingly, during splaying the desired front tool D* is pushed upwards by the clamping shoulder 26 of the upper gripping fingers 22 and thus moves away from the radial arm 3, on which it is stored (cf. FIGS. 8 and 9).

To prevent the rear adhering tool D from also sliding upwards, it is held down by the lower gripping finger 22U with the offset clamping shoulder 26 thereof.

By virtue of the fact that the rear adhering tool D slides in front of the compressed air nozzles of the upper gripping fingers 22, the effect of the compressed air pushing away the tool located behind it increases. In this case, all three gripping fingers extend uniformly at the same time. If the gripping fingers are fully extended, the unwanted tool is held or clamped by means of the clamping shoulder of the lower gripping finger, and the gripping head can move away with the desired tool.

In addition, the compressed air nozzles 27* on the clamping shoulder 26 of the lower gripping finger 22U can be designed differently. The compressed air nozzles 27* are oriented in the opposite direction to the remaining ones, extending in the axial-radial direction obliquely from the outside to the inside in the direction of access and extending in the opposite direction, and so the compressed air is ejected towards the wedge-shaped tip 23 (push-off wedge) and acts on the desired tool D*.

In order to accommodate different inner diameters of the tools and to generate different clamping forces, the gripping fingers 22 are designed to be movable radially in a controlled manner with regard to the extent of the extension length. It is possible to set the force separately and individually via the controller 1000 and, in the case of recurring tools, to achieve targeted presetting for the best clamping force.

Changes and modifications in the specifically described embodiments can be carried out without departing from the principles of the present invention which is intended to be limited only by the scope of the appended claims, as interpreted according to the principles of patent law including the doctrine of equivalents.

1. An apparatus for automatically handling hollow cylindrical tools comprising:
a gripping head having at least two radially extendible fingers that each form an angle of greater than 90 degrees therebetween;
wherein the fingers are radially moveable between a rest position and a gripping position in order to engage into the tools in the rest position and clamp them in a splaying manner in the gripping position, and wherein each finger comprises an end region and is configured to generate a directed repulsive force at the end region.

2. The apparatus of claim 1, wherein each finger comprises a force generator device at the end region of the finger.

3. The apparatus of claim 2, wherein the force generator device of each finger comprises a compressed air nozzle.

4. The apparatus of claim 1, wherein the gripping head further comprises a vibration device.

5. The apparatus of claim 4, wherein the vibration device is configured to vibrate the gripping fingers.

6. The apparatus of claim 1, further comprising a linear drive, wherein the linear drive is configured to move the fingers.

7. The apparatus of claim 6, wherein the linear drive comprises a toggle lever mechanism.

8. The apparatus of claim 7, wherein the toggle lever mechanism is driven via a ball screw drive.

9. The apparatus of claim 1, wherein the fingers are radially moveable with respect to an extent of an extension length.

10. The apparatus of claim 1, wherein the gripping head comprises three radially extendible fingers that each form an angle of 120 degrees therebetween.

11. The apparatus of claim 1, wherein the end region of each of the fingers comprises a tapering end region.

12. The apparatus of claim 11, wherein each of the gripping fingers have an outer and/or inner clamping shoulder at a transition to the tapering end regions.

13. The apparatus of claim 1, wherein the hollow cylindrical tools do not include a reduction in a wall thickness on inner edges of slitting lines of the tools.

14. A method for automatically handling an individual hollow cylindrical tool from a group of tools lying against one another, said method comprising:
providing a gripping head having at least two radially extendible fingers that each form an angle of greater than 90 degrees therebetween;
holding the hollow cylindrical tool in a clamping manner from inside the hollow cylindrical tool by introducing and spreading the fingers of the gripping head;
generating a directed repulsive force with the fingers and/or vibrating the fingers in order to detach the hollow cylindrical tool from another hollow cylindrical tool adhered to the hollow cylindrical tool.

15. The method of claim 14, wherein said generating a directed repulsive force with the fingers comprises blowing air from the fingers.

16. The method of claim 15, wherein each finger comprises a compressed air nozzle.

17. The method of claim 16, wherein each finger comprises an end region and wherein the air nozzle of each finger is disposed at the end region.

18. The method of claim 14, wherein the gripping head further comprises a vibration device configured to vibrate the gripping fingers.

19. The method of claim 14, wherein the gripping head comprises three radially extendible fingers that each form an angle of 120 degrees therebetween.

20. The method of claim 14, wherein said spreading the fingers of the gripping head comprises radially moving the fingers between a rest position and a gripping position in order to engage into the tools in the rest position and clamp them in a splaying manner in the gripping position.
